(19) United States
(12) Patent Application Publication
(10) Pub. No.: US 2009/0265269 A1
(43) Pub. Date: Oct. 22, 2009

(54) System and Method for Providing a Swap System in a Network Environment

(76) Inventor: Mark A. Stoecker, Flower Mound, TX (US)

Correspondence Address: Patent Capital Group, 6119 McCommas Blvd, Dallas, TX, 75214, US

(21) Appl. No.: 12/106,158

(22) Filed: Apr. 18, 2008

(51) Int. Cl. G06Q 40/00

(52) U.S. Cl. 705/39

(57) ABSTRACT

A swap system is provided that includes an interchange platform operable to receive and process transaction information from one or more companies that are included in a group of network companies. The transaction information being generated by one or more end users transferring a first monetary value from a first gift card issued by a first company, belonging to the group of network companies, to a universal card such that the universal card reflects a discounted second monetary value. The end user can use the universal card in a transaction involving a second company belonging to the group of network companies. The first company is required to credit back a majority of the first monetary value through the swap system. In more particular embodiments, a swap network entity is provided that receives a fee based on transactional activity in the swap system.

### BACKGROUND OF THE INVENTION

Consumer preferences and shopping patterns have grown increasingly complex in recent years. As the typical shopper has become more sophisticated, trying to find the ‘perfect gift’ has also become a challenging endeavor. Specific age groups can also be difficult to accommodate. For example, both children and older citizens have unique interests and exact preferences in what they seek to purchase. This shopping quandary, in conjunction with ordinary gift purchases, has spawned the conventional gift card, which has become a popular choice for many shoppers.

However, these conventional gift cards are not always an ideal shopping solution. First, some gift cards are sponsored by companies that have no appeal to the intended gift recipients. Such a situation causes some gift cards to not be redeemed or, alternatively, gift recipients settle for inferior goods from stores in which they would otherwise never shop. Other problems also arise when unwanted gift cards include fees and charges from non-use or delayed-use, such that the buying power of the gift recipient is systematically eroded.

Ultimately, in all of these scenarios, the merchants win and the consumer has lost value. Currently, there are numerous approaches to addressing the inefficiencies caused by receiving unwanted gift cards. One approach involves using a Kiosk exchange in a crude attempt to return or reconcile some value to the gift card recipient. Other flawed approaches involve simple auction sites, where a gift card recipient trying to sell an unwanted gift card would be at the mercy of the auction market (i.e., simple supply/demand constraints would affect gift card redemption prices). Where there are enough willing buyers, the gift card recipient may be able to salvage a reasonable percentage of the original value of the gift card. Unfortunately, rarely does this happen for the consumer who is saddled with a gift card they cannot use.

Accordingly, the ability to provide an effective mechanism to properly process and address consumer needs offers a significant challenge to retailers, bankers, and card-processors alike.

### SUMMARY OF THE INVENTION

In accordance with certain embodiments of the present invention, techniques for supporting a swap system are provided that substantially eliminate or effectively reduce problems and deficiencies of other gift card solutions.

According to a particular embodiment, a swap system is provided that includes an interchange platform operable to receive and process transaction information from one or more companies that are included in a group of network companies. The transaction information being generated by one or more end users transferring a first monetary value from a first gift card issued by a first company, belonging to the group of network companies, to a universal card such that the universal card reflects a discounted second monetary value. The end user can use the universal card in a transaction involving a second company belonging to the group of network companies. The first company is required to credit back a majority of the first monetary value through the swap system.

In more particular embodiments, a swap network entity is provided that receives a fee based on transactional activity in the swap system. The swap network entity receives a royalty or a licensing fee from one or more entities involved in the swap system. In still other embodiments, the universal card does not include any information that would identify a selected one of the end users.

In yet other embodiments, the difference between the first monetary value and the discounted second monetary value is shared between one or more parties. These parties could include a member of the network companies, a swap network entity, a bank, the end user in the form of a future coupon or rebate, the interchange platform, or a credit-card processing entity.

In more detailed embodiments, the end user [consumer] is required to become a member of the swap system before using the universal card. The universal card can be loaded by the end via a cash account or a credit card account such that the universal card is credited with increased purchasing power. Additionally, the network companies are required to become a member before participating in the swap system.

Embodiments of the invention provide various technical advantages. Other technical advantages of the present invention will be readily apparent to one skilled in the art from the following figures, descriptions, and claims. Moreover, while specific advantages have been enumerated herein, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram that illustrates a swap system for interfacing between end users and merchants in accordance with one embodiment of the present invention;

FIG. 2 is a simplified schematic diagram of a process flow for the swap system; and

FIG. 3 is a simplified schematic diagram that offers an example fee structure associated with the swap system.

### DETAILED DESCRIPTION OF THE INVENTION

Note that for purposes of teaching and discussion, it is useful to provide some background overview as to the way in which the tendered invention operates. The following foundational information describes some of the problems/arrangements that may be solved/addressed by the present invention. This general information may be viewed as a basis from which the present invention may be properly explained. Such information is offered earnestly for purposes of explanation only and, accordingly, should not be construed in any way to limit the broad scope of the present invention and its potential applications.

There are a plethora of gift cards in the current marketplace and each parent company of the card [being distributed] seeks to strengthen branding for their respective cards. The gift card recipient is typically beholden to the sponsoring entity. For example, a gift card from a retailer such as ‘The Gap’ would only be redeemable at one of their store locations (or possibly at the Gap sponsored website).

For customers that do not desire to shop at the parent company, there are few options given to them. One such option may be to sell the card to a 3^{rd} party: for example, employing the use of eBay's auction market. There are other websites [such as www.swapagift.com] that facilitate trading of gift cards amongst gift card recipients. In that model, a given end user posts their unwanted gift card information and then inputs some of their preferred gift card substitutes that he/she would like to receive in exchange for their current unwanted gift card.

The problem with both of these bartering systems is that they cannot accommodate all end users intelligently. In addition, the entity that facilitates the trade typically charges an excessive fee for the ability to trade the card. In one sense, these strategies share an auction theme, which is deficient in many aspects.

In contrast to such operations, the present invention offers a network-based ideal solution for addressing gift card swaps. In accordance with the teachings of the present invention, a swap system 10 is offered to address the discussed shortcomings of other swap systems that offer solutions that are disadvantageous to the consumer.

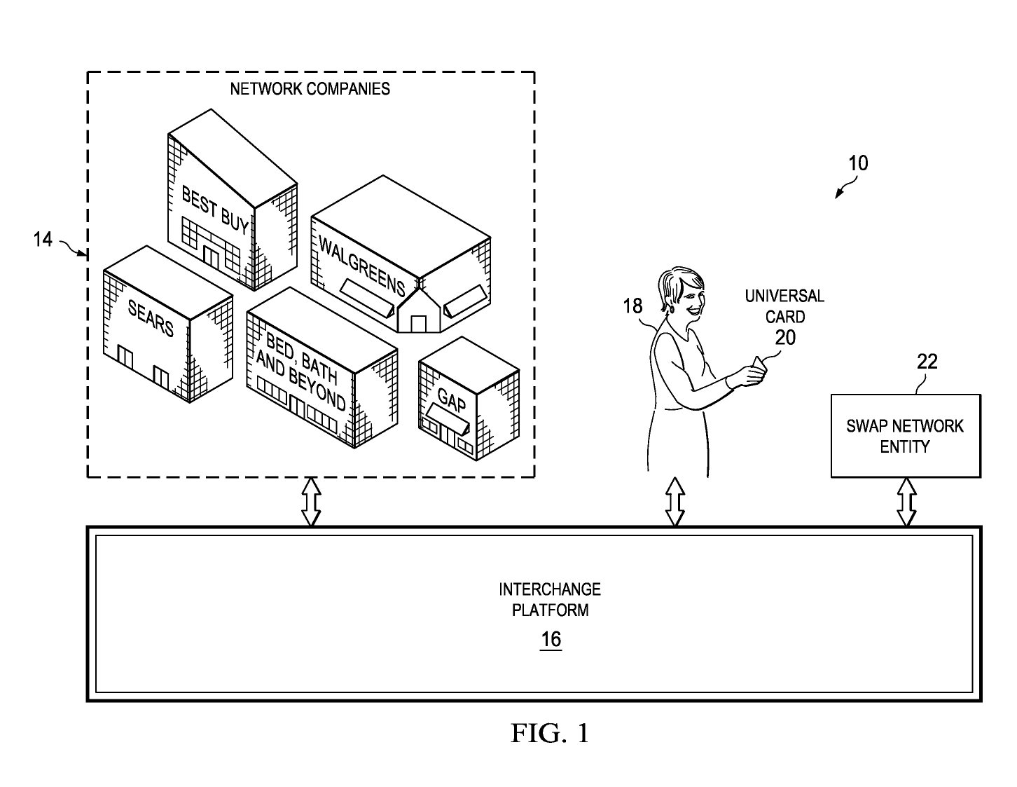

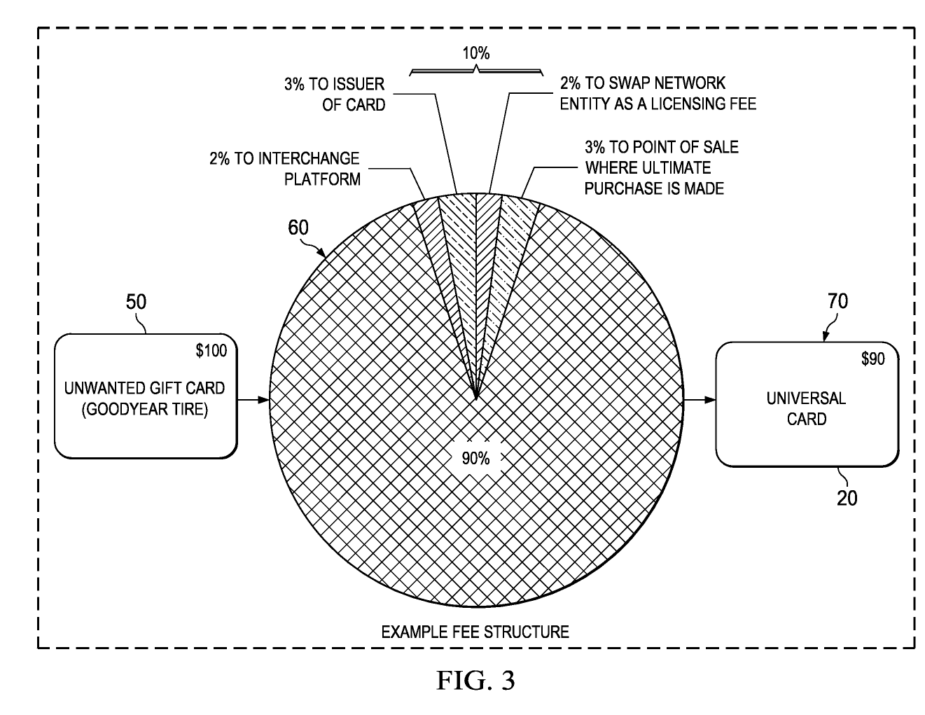

FIG. 1 illustrates swap system 10, which can support any type of electronic transmissions and electronic communications. In this one non-limiting embodiment, swap system 10 includes an interchange platform 16 (e.g., First Data Corporation, Metabank, etc.) that acts as a proverbial hub in processing [and possibly escrowing] electronic transactions. Interchange platform 16 could also be a bank or a credit card company (such as American Express, for example). Swap system 10 also includes a swap network entity 22 that does not actively participate in the transactions, but that collects a nominal licensing fee for each transaction. For example, swap network entity 22 could charge a flat 2% on each transaction conducted in swap system 10. Other percentages or other business arrangements could readily be adopted by swap system 10, as this is just one type of arrangement that could be employed. An example fee structure is further detailed below with reference to FIG. 3.

Swap system 10 also includes a group of network companies 14 that stand ready to redeem gift cards issued by members of the network. A given end user 18 may present a universal card 20 to network companies 14 at their places of operation (either physical property locations or in an electronic environment). When gift cards are received by end user 18, he can quickly convert those gift card values over to universal card 20 (although not necessarily at an exact exchange rate, as further detailed below).

Thus, there are two memberships that should be secured in such a swap arrangement. First, end user 18 must be issued universal card 20. This issuance would typically be preceded by end user 18 filling out simple paperwork such that they join the general swap network. This could be a free membership, or a surcharge could apply in other embodiments of the present invention. In still other scenarios, end users are enticed to join the network through a bonus point system, coupons, a discount system, or any other incentive systems. The second membership is amongst network companies 14 and this membership is further detailed below with reference to the discussion of network companies 14.

Network companies 14 are an organized group of entities that wish to participate in swap system 10. Network companies 14 could be any company that seeks to avail itself to the swap functionality of the present invention. Such companies could include restaurants, retailers, on-line merchants, grocery stores, gas stations, banks, credit-card companies, or any other suitable entity that could benefit from the teachings of the present invention. In operation, network companies 14 agree to honor each other's gift cards through the swap arrangement. Note that there is not a full redemption on these unwanted gift cards, as they are discounted slightly as they are loaded onto universal card 20. A number of examples, as well as an example fee structure, are described herein and discussed in greater detail below.

Universal card 20 serves as a transaction instrument in that any gift card received by end user 18 can be loaded (i.e., value is transferred) onto universal card 20. Universal card 20 could implicate a membership application and corresponding customer profile. Alternatively, universal card 20 could be an anonymous account (much like current Starbucks' cards) where the vendor does not care about the identity of the ultimate end user. Identity theft would not be an issue in such a scenario. In one sense, these anonymous reloadable cards do offer some privacy for consumers in regards to their purchases.

In other scenarios, an accurate and robust profile is provided with each universal cad 20. This profile could perfectly track all purchasing activity for the end user. Universal card 20 may include a magnetic strip, bar code, embedded chip, wireless technology, infrared components, or any other component that serves to account for value on the card. Universal card 20 may be loaded through a cash account (a conventional bank account), through a credit card, or through other gift cards, as outlined herein in this Specification. Thus, universal card 20 can be readily loaded with monetary value by the end user such that the universal card is credited with increased purchasing power.

Note also that the term ‘card’ as used herein in this document connotes any portable device that is capable of storing financial data that could be used in the course of a merchandising transaction. As technology continues to move toward small electronic devices (such as swipe-able sticks and fobs that include data that can easily be read by scanning devices), it is expected that some of the teachings of the present invention could certainly migrate to such technologies. As such, the term ‘universal card’ includes any such technology that is capable of performing the operations of the card, as explained herein.

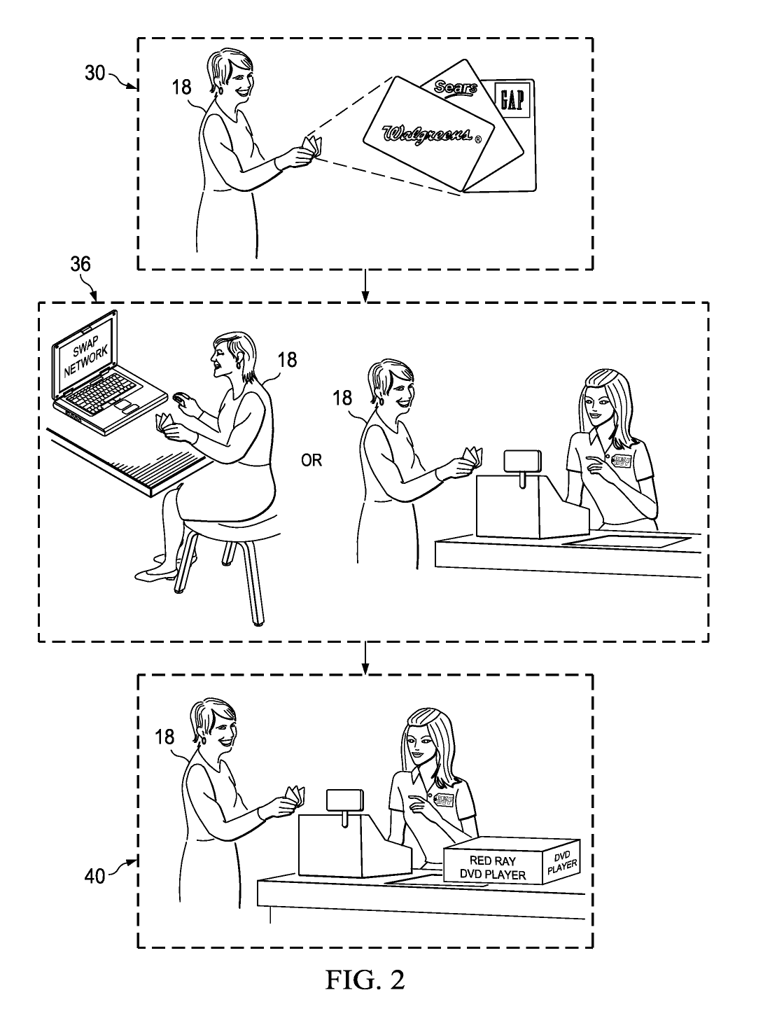

Before turning to FIG. 2 and some explanatory examples, the components illustrated in FIG. 1 are further described for the benefit of the audience.

Interchange platform 16 represents an entity that processes/coordinates activities for swap system 10. This could be a corporation/company/group of individuals that provide this service to swap system 10. In other embodiments, interchange platform 16 is an autonomous electronic component: representing a communications platform, including hardware and any appropriate controlling logic, for providing electronic processing for gift cards that flow into swap system 10. Various banking and credit-card protocols and technologies may be used by interchange platform 16 to achieve this processing. Interchange platform 16 may provide management functions for participating network companies 14. Thus, each network company 14 would have their transaction accounted for by interchange platform 16. This record keeping function could be provided along with escrowing operations, as well as debit and credit coordination amongst the participants in swap system 10.

Interchange platform 16 may also include additional components such as a local area network (LAN), a wide area network (WAN), and/or any other appropriate form of network that facilitates processing of these transactions. Furthermore, elements within interchange platform 16 may utilize circuit-switched and/or packet-based communication protocols.

It should also be noted that the internal structure and inherent functions of interchange platform 16 and universal card 20 are malleable and can be readily changed, modified, rearranged, or reconfigured in order to achieve their intended operations, as they pertain to the swap function outlined herein in this document. Software and/or hardware may reside in either of these elements [or both] in order to achieve the teachings of the swap features of the present invention. However, due to their flexibility, these elements may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structures of interchange platform 16 and universal card 20 in the context of swap system 10 and, accordingly, they should be construed as such.

End user 18 is simply a person who seeks to participate in swap system 10. End user 18 may use any suitable device for communications in swap system 10. The term ‘end user’ is not exclusive to a human entity, as it may include a number of peripherals that facilitate communications or activities performed by a participant in swap system 10. For example, the term ‘end user’ may encompass a communications interface for an end user of swap system 10. End user 18 may employ the use of a cellular or other wireless telephone, an electronic notebook, a computer, a personal digital assistant (PDA), or any other device, component, or object capable of initiating a data exchange facilitated by swap system 10. End user 18 may also leverage any suitable interface to the human user or to a computer, such as a display, microphone, keyboard, or other terminal equipment (such as for example an interface to a personal computer. End user 18 may alternatively represent any device or object that seeks to initiate a communication on behalf of another entity or element, such as a program, a database, or any other component, device, element, or object capable of initiating a voice or a data exchange within swap system 10. Data, as used herein in this document, refers to any type of numeric, voice, video, audio-visual, or script data, or any type of source or object code, or any other suitable information in any appropriate format that may be communicated from one point to another.

Network companies 14 are simply merchants, card-issuers, or sponsoring companies that have joined swap system 10 (through some type of legal agreement or through some sort of qualifying membership activity). The membership could be free, or a charge could be applied by swap system 10.

Swap network entity 22 is simply a third-party company that receives some transactional fee or licensing fee, as the swap system is utilized. In some cases, this entity does not actively participate in the transaction and is not necessarily connected to the swap system. For example, swap network entity 22 could simply collect an annual royalty or quarterly licensing fees based on revenues generated by swap system 10, or based on other royalty arrangements.

FIG. 2 is a simplified schematic diagram of a process flow for swap system 10. FIG. 2 offers a given example where a given end user has received multiple cards on her Birthday. In this example, at a first stage 30, end user 18 has received gift cards from the Gap, Sears, and Walgreens. Unfortunately, this presents a problem for her because she has no need for items carried by these merchants.

End user 18 wishes to purchase a DVD-player that she has recently seen being offered at BestBuy. In this example, end user 18 is (fortunately) a member of the swap network. She understands that she can transition the values of the gift cards over to her universal card 20. At a second stage 36, there are two options for end user 18. One option involves her doing the swap operations in a network-based approach. The second option would achieve the same gift card redemption directly at a merchant's physical location with the help of a salesperson.

In the first graphical depiction of second stage 36, end user 18 uses information found on each of her gift cards to convert values of the gift cards received to her universal card 20 (not shown). This card information could be numeric codes or tracking numbers on the face of the card (or the back of the card) that identify the card and its associated value. At the conclusion of this inputting of information stage, universal card 20 would display a balance. She is now free to dispose of those original gift cards, as they have been electronically zeroed out. The value of those cards now appears on her universal card 20.

In the second depiction of second stage 36, end user 18 offers all the cards to a salesperson at BestBuy who loads all her gift cards onto universal card 20. Note that in this scenario, the desired DVD-player is retailing for $200, whereas each of the gift cards that she has received are only $75 (i.e., total value of the three cards is $225). So, from the outset, she has the ‘value’ to make the $200 purchase, but no means to accomplish her goal without having swap system 10.

A third stage 40 in this example scenario illustrates the resultant of such a system. End user 18 shops at her preferred merchant and secures the DVD-player that she wishes to purchase. Thus, swap system 10 has worked perfectly in offering an ideal solution for end user 18, while fostering business for a member of network companies 14. Customer satisfaction is increased and the customer feels as though she has been treated fairly and also maximized her gift card dollars.

Note that in such a scenario, it is end user 18 who is empowered to choose between merchants. Initially, end user 18 was bound to a single store when she received each gift card. With swap system 10, she has broadened her choices and now she can choose various potential stores in which she can make her purchase.

In regards to data collection, on the merchant side, there is an ancillary benefit in harvesting data associated with purchases made by end user 18. Specifically, shopping patterns and behavior can be noted and studied by participating members in swap system 10. This marketing data is invaluable to many sophisticated merchants. Other benefits to the participating merchants include a better/clearer accounting of outstanding (but unused) gift cards. Typically, unused gift cards are treated as unearned revenue (a liability on the Balance Sheet) until they are ultimately redeemed. This uncertainty, as to when or if the gift card will eventually be redeemed, does create an accounting complication, which can be effectively eliminated by swap system 10.

Additionally, participation by end users would be higher with use of swap system 10, as consumers will be engaged to shop at the various network companies 14. More choices offer better value for the consumer. It is also worth noting that by using universal card 20, a consumer is not being exposed to a potential bankruptcy of the gift card's sponsor. Such a bankruptcy (e.g., as was the case with the Sharper Image Corporation) would likely render their gift cards worthless. This risk is avoided by swap system 10.

FIG. 3 is a simplified schematic diagram that offers an example fee structure 60 associated with swap system 10. In this example, the recipient has received an unwanted gift card 50 from a tire store (GoodYear Tire). However, this recipient would like to purchase something from the Gap and has no need for merchandise at the gift card's sponsor. The original gift card value was $100 and she would like to convert that value to something that would allow her to make purchases at the Gap.

In this scenario, the recipient is not a member of the swap system when she arrives at the Gap. The Gap has been properly authorized to issue universal card 20 after requisite paperwork has been completed by the gift card holder. Thus, a point of sale location can quickly process a universal card request. The recipient in this case has no interest in using the $100 GoodYear gift card, so she is in difficult situation. Realizing that having at least some value for this card, as opposed to never using the unwanted gift card at all, is a better alternative, she agrees to sacrifice $10 or 10% of this card's value, as its value is transferred to universal card 20.

This 10% metric is the agreed-upon value, as negotiated between GoodYear Tire (a member of network companies 14) and swap system 10. In this example, interchange platform 16 collects a 2% transaction fee, which is $2 in this example. Swap network entity 22 also collects licensing fees for the transaction (also $2 in this example). The original gift card issuer (GoodYear Tire) will receive 3% ($3 in this example) and yet he has not offered any service or sacrificed inventory/merchandise to end user 18. In this sense, the original gift card issuer is incentivized to participate in the program. GoodYear Tire in this example has to send (or credit) $90 back through the network to interchange platform 16, where it could be held in escrow. These numbers are based on a stipulated agreement between network companies 14. The ‘credit back’ language is meant to connote any type of arrangement in which the original merchant gives back (in any form, either directly, indirectly, through some type of reconciliation with the swap system, through a write-off, etc.) some portion of the original amount that it received from the end user.

The final 3% is offered to the point of sale (POS) entity, which is the Gap in this example. A final discounted card resultant 70 is also depicted in FIG. 3. Discounted card resultant 70 has a value of $90, which can be fully realized at the Gap or any other participating network company of swap system 10.

Note that there are four parties in the transaction presented here in this example, but there could certainly be less or more depending on particular needs or specific financial arrangements. Moreover, these outlined percentages are completely arbitrary, as each could range from 0%-100% in terms of reconciling amounts associated with swap system 10 or in divvying out different proportions to each participant. Thus, these tendered percentages should be interpreted as merely examples to illustrate some of the features of the present invention.

It is critical to note that the stages and steps in FIGS. 2-3 illustrate only some of the possible scenarios and operations that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within swap system 10 to effectuate the tasks and operations of the elements and activities associated with executing swap transactions.

Although the present invention has been described in detail with reference to particular embodiments, it should be understood that various other changes, substitutions, and alterations may be made hereto without departing from the spirit and scope of the present invention. The illustrated network architecture of FIG. 1 has only been offered for purposes of example and teaching. Suitable alternatives and substitutions are envisioned and contemplated by the present invention: such alternatives and substitutions being clearly within the broad scope of swap system 10.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims.

What is claimed is:

1. A swap system, comprising:
an interchange platform operable to receive and process transaction information from one or more companies that are included in a group of network companies, the transaction information being generated by one or more end users transferring a first monetary value from a first gift card issued by a first company, belonging to the group of network companies, to a universal card such that the universal card reflects a discounted second monetary value, whereby the end user can use the universal card in a transaction involving a second company belonging to the group of network companies, and wherein the first company is required to credit back a majority of the first monetary value through the swap system.

2. The swap system of claim 1, further comprising:
a swap network entity that receives a fee based on transactional activity in the swap system.

3. The swap system of claim 1, further comprising:
a swap network entity that receives a royalty or a licensing fee from one or more entities involved in the swap system.

4. The swap system of claim 1, wherein the universal card does not include any information that would identify a selected one of the end users.

5. The swap system of claim 1, wherein the end user authorizes the transaction that reduces the first monetary value to the discounted second monetary value.

6. The swap system of claim 5, wherein a difference between the first monetary value and the discounted second monetary value is shared between one or more parties.

7. The swap system of claim 6, wherein the parties include a selected one of a group of parties, the group consisting of:
a) a member of the network companies;
b) a swap network entity;
c) a bank;
d) the end user in the form of a future coupon or rebate;
e) the interchange platform; and
f) a credit-card processing entity.

8. The swap system of claim 1, wherein the end user is required to become a member of the swap system before using the universal card.

9. The swap system of claim 1, wherein the network companies are required to become a member before participating in the swap system.

10. The swap system of claim 1, wherein the universal card can be loaded by the end via a cash account or a credit card account such that the universal card is credited with increased purchasing power.

11. A method, comprising:
transferring a first monetary value from a first gift card issued by a first company, belonging to a group of network companies, to a universal card such that the universal card reflects a discounted second monetary value, whereby an end user can use the universal card in a swap system for a transaction involving a second company belonging to the group of network companies, and wherein the first company is required to credit back a majority of the first monetary value through the swap system.

12. The method of claim 11, further comprising:
receiving and processing transaction information from one or more companies that are included in the group of network companies, the transaction information being generated by the end user.

13. The method of claim 11, further comprising:
loading the universal card via a cash account or a credit card account such that the universal card is credited with increased purchasing power.

14. The method of claim 11, wherein the universal card does not include any information that would identify a selected one of the end users.

15. The method of claim 11, wherein the end user authorizes the transaction that reduces the first monetary value to the discounted second monetary value.

16. The method of claim 11, wherein a difference between the first monetary value and the discounted second monetary value is shared between one or more parties.

17. The method of claim 16, wherein the parties include a selected one of a group of parties, the group consisting of:
a) a member of the network companies;
b) a swap network entity;
c) a bank;
d) the end user in the form of a future coupon or rebate;
e) the interchange platform; and
f) a credit-card processing entity.

18. The method of claim 11, wherein the end user is required to become a member of the swap system before using the universal card.

19. The method of claim 11, wherein the network companies are required to become a member before participating in the swap system.

20. The method of claim 11, further comprising:
extracting a fee for a swap network entity based on activities in the swap system.
